(19) United States
(12) Patent Application Publication
(10) Pub. No.: US 2025/0314224 A1
(43) Pub. Date: Oct. 9, 2025

(54) AIRBOX FOR A TWO-WHEELED VEHICLE

(71) Applicant: Indian Motorcycle International, LLC, Medina, MN (US)

(72) Inventors: Joseph W. Klein, Wyoming, MN (US); Matthias Botta, Burgdorf (CH); Juho Pekka Wuollet, Wyoming, MN (US); Benjamin W. Moscherosch, Wyoming, MN (US)

(73) Assignee: Indian Motorcycle International, LLC, Medina, MN (US)

(21) Appl. No.: 18/872,653

(22) PCT Filed: Jun. 6, 2023
(86) PCT No.: PCT/US2023/068016

§ 371 Date: Dec. 6, 2024

Related U.S. Application Data
(60) Provisional application No. 63/349,819, filed on Jun. 7, 2022.

(51) Int. Cl. F02M 35/16; B62J 40/10; B62J 41/00; F02M 35/02; F02M 35/10

(52) U.S. Cl. CPC F02M 35/162; B62J 40/10; B62J 41/00; F02M 35/0201; F02M 35/10

(57) ABSTRACT

A two-wheeled vehicle may include a frame, a plurality of ground-engaging members for supporting the frame and an engine supported by the frame and operably coupled to the ground-engaging members. Additionally, the two-wheeled vehicle may include an airbox including inlet tube and a filter. The airbox may include by a first housing portion, a second housing portion, and a vertical seam coupling the first and second housing portions.

### RELATED APPLICATION

This application claims the benefit of U.S. Provisional Patent Application No. 63/349,819, filed Jun. 7, 2022, the entire disclosure of which is expressly incorporated by reference herein.

### FIELD OF THE DISCLOSURE

The present disclosure relates to an airbox for a vehicle and, more particularly, to an airbox for a two-wheeled vehicle with increased ease of manufacturing.

### BACKGROUND OF THE DISCLOSURE

Conventional two-wheeled vehicles include a frame for supporting an operator. The frame may also support a passenger rearward of the driver. An engine is typically positioned below the driver and is coupled to the frame. The front of the vehicle may include a panel or cover positioned forward of the driver for supporting additional components of the vehicle, for example a light. The rear of the vehicle may include a cargo area, for example saddle bags extending laterally outward from the frame.

Such vehicles typically include an airbox as part of the air intake assembly fluidly coupled to the engine. The airbox may include a filter, a tray, an inlet tube, an oil separator, and various other components. Because space on such vehicle may be constricted, there is a need to support the airbox on a two-wheeled vehicle without interference with other components of the vehicle.

### SUMMARY OF THE DISCLOSURE

In an exemplary embodiment of the present disclosure, a two-wheeled vehicle comprises a frame and a plurality of ground-engaging members for supporting the frame. Additionally, the two-wheeled vehicle comprises an airbox including a left housing, a right housing distinct from the left housing, and a vertical seam separating the left and right housings.

A further exemplary embodiment of the present disclsoure includes a two-wheeled vehicle comprising a frame and a plurality of ground-engaging members for supporting the frame. Additionally, the two-wheeled vehicle comprises an airbox including a first housing portion, a second housing portion distinct from the first housing portion, and a filter positioned within one of the first housing portion and the second housing portion.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 is a left side view of a schematic representation of a two-wheeled vehicle of the present disclosure;

FIG. 2 is a top view of the two-wheeled vehicle of FIG. 1;

FIG. 3 is a side view of a portion of a frame and an airbox coupled to the vehicle of FIG. 1;

FIG. 4 is a cross-sectional view of a portion of a frame and an airbox coupled to the vehicle of FIG. 1;

FIG. 5 is a front view of the frame and an air inlet of the airbox of FIG. 3;

FIG. 6 is a right rear partially exploded view of the frame and airbox of FIG. 3;

FIG. 7 is a side view of a portion of the frame depicting the installation and removal of the airbox of FIG. 3;

FIG. 8 is a top right rear perspective view of the airbox of FIG. 3;

FIG. 9 is a bottom left front perspective view of the airbox of FIG. 3;

FIG. 10 is a front exploded view of the airbox of FIG. 3;

FIG. 11 is a top partially exploded view of the airbox of FIG. 3;

FIG. 12 is a top right rear perspective view of the left housing of the airbox of FIG. 3; and

FIG. 13 is top left rear perspective view of the right housing of the airbox of FIG. 3.

Corresponding reference characters indicate corresponding parts throughout the several views. Unless stated otherwise the drawings are proportional.

### DETAILED DESCRIPTION OF THE DRAWINGS

The embodiments disclosed below are not intended to be exhaustive or to limit the invention to the precise forms disclosed in the following detailed description. Rather, the embodiments are chosen and described so that others skilled in the art may utilize their teachings. While the present invention primarily involves a standard motorcycle, it should be understood, that the invention may have application to other types of vehicles such as all-terrain vehicles, motorcycles, watercraft, utility vehicles, scooters, golf carts, and mopeds.

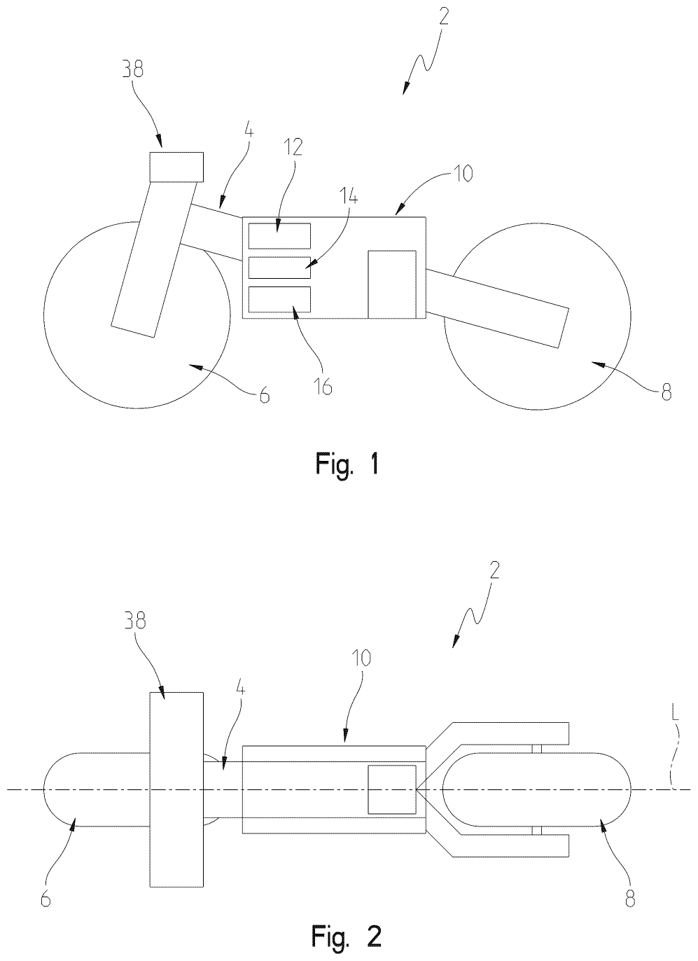

With reference first to FIGS. 1-2, an illustrative embodiment of a two-wheeled vehicle 2 is shown. Vehicle 2 as illustrated is a motorcycle and may be configured for cruising, touring, sport, dirt bike, or other various operational applications as described herein.

Vehicle 2 includes a frame 4 supported by ground engaging members, namely a front ground engaging member, illustratively front wheel 6, and a rear ground engaging member, illustratively rear wheel 8. Vehicle 2 travels relative to the ground on front wheel 6 and rear wheel 8. The front wheel 6 and rear wheel 8 are generally aligned along a centerline L of vehicle 2. While vehicle 2 is a two-wheeled vehicle, various embodiments of the present disclosure may include three, four, five, or six-wheeled vehicles. A front fender (not shown) may be partially positioned around the front wheel 6 and may include a light or reflector. Similarly, a rear fender (not shown) may be positioned around the rear wheel 8. Additionally, a brake assembly (not shown) is operably coupled to the front wheel 6 and/or rear wheel 8.

Frame 4 of vehicle 2 may include a mid-frame assembly 10 for supporting a fuel tank 12, an airbox 14, and an engine 16. Mid-frame assembly 10 or other portions of frame 4, such as a front frame portion or a rear frame portion, may support a cooling assembly, a transmission, a rear suspension assembly, and an operator seat. Front and/or rear wheel(s) 6, 8 are operably coupled to engine 16 to propel vehicle 2 along the ground surface. The engine 16 may be a spark-ignition gasoline engine, electric motor or other suitable torque-generating machines that are operable with various embodiments of the present teachings.

Vehicle 2 also includes a front suspension assembly, a steering assembly 38, operator controls and other systems. Steering assembly 38 includes handlebars which may be moved by an operator to rotate front wheel 6 either to the left or the right. Steering assembly 38 is coupled to vehicle 2 through a triple clamp assembly. The triple clamp assembly may be operably coupled the front suspension assembly through down tubes 22.

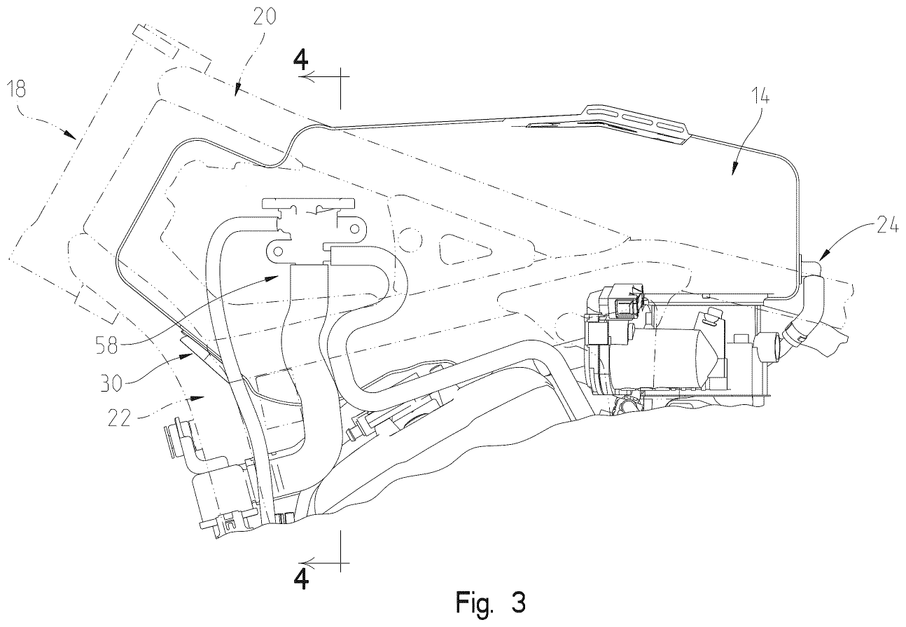

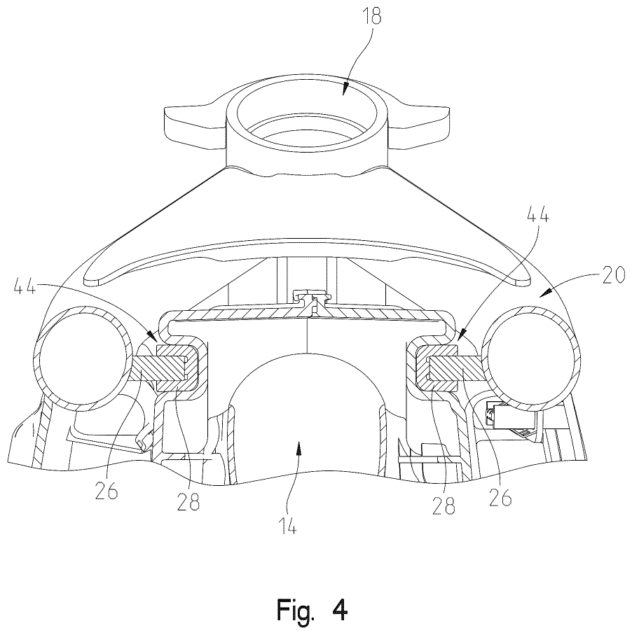

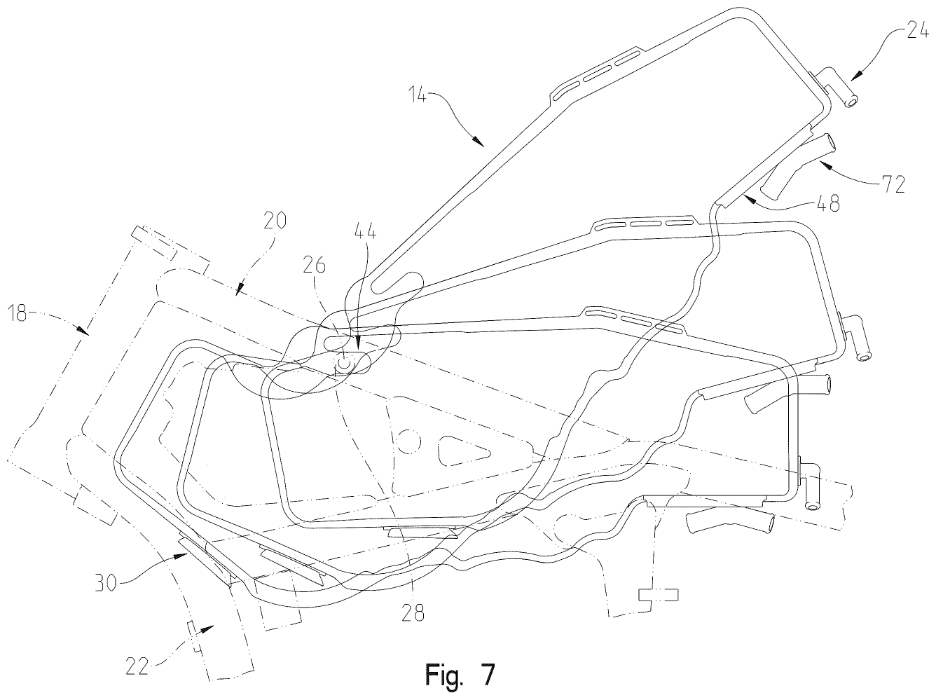

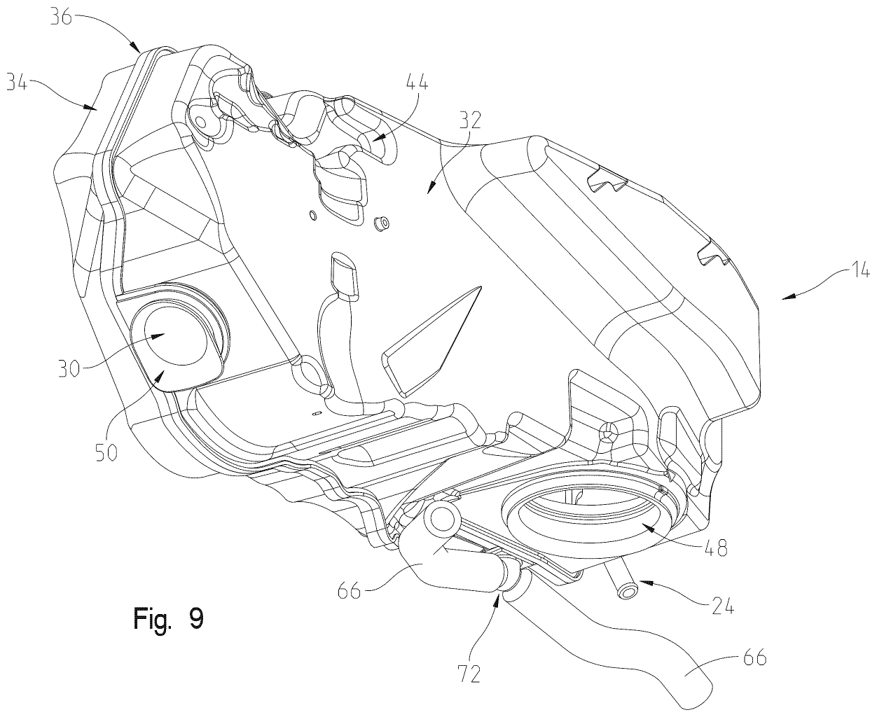

Referring now to FIGS. 3-13, airbox 14 is supported within a portion of frame 4 and generally positioned below the fuel tank 12 (FIG. 1), above the engine 16 (FIG. 1), and between lateral frame arms 20. At least a portion of airbox 14 is behind down tubes 22 and head tube 38 and positioned generally along longitudinal centerline L (FIG. 1). In one embodiment, airbox 14 is directly coupled to engine 16 through a throttle body assembly 46, as disclosed further herein. Referring to FIGS. 4, 6, and 7, the airbox 14 is coupled to the frame 4 at recessed mount 44 by a pin 26 and a bushing 28. The bushing 28 provides the benefit of additional friction and lateral damping to stabilize the airbox 14 and isolate airbox from vibrations in frame 4. The pin 26 may be welded to the frame 4 and, in one embodiment, pin 26 may be approximately 8 millimeters in diameter. As shown in FIG. 7, the airbox 14 may be installed or removed as a single unit, without tools or clamps, by rotating the airbox 14 about the center axis of the pin 26 and bushing 28. The installation and removal procedure enables airbox 14 to be rapidly exchanged for another airbox 14 with different performance characteristics, as described below.

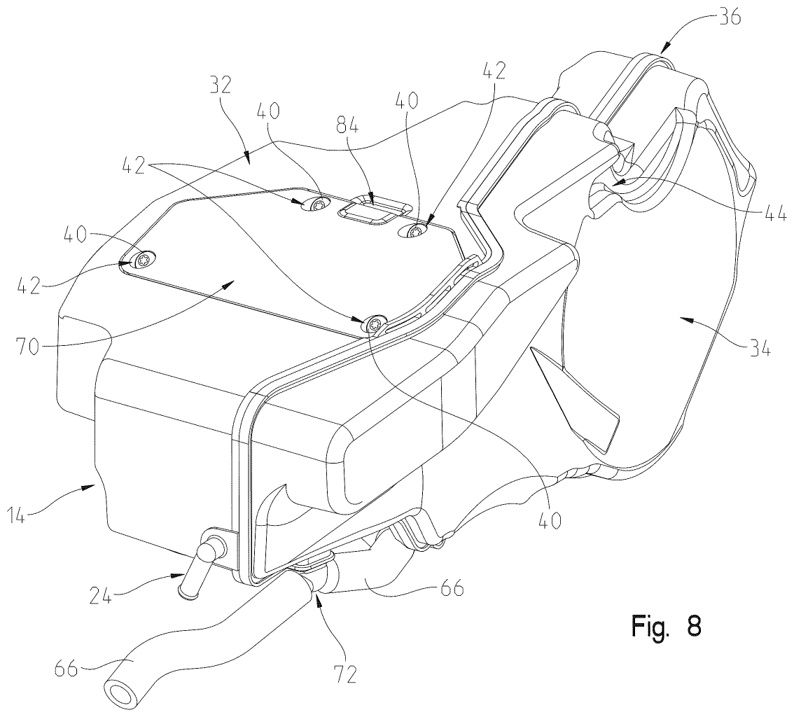

As shown in at least FIG. 8, airbox 14 includes a left housing 32 and right housing 34 which are coupled to each other along a vertical seam 36. In one embodiment, left and right housings 32, 34 may be permanently coupled to each other along vertical seam 36 via vibration welding, rivets, adhesive, or the like; however, in other embodiments, left and right housings 32, 34 are removably coupled to each other with removable fasteners (e.g., nuts) along seam 36. Vertical seam 36 extends vertically along at least front and rear faces of airbox 14 and extends longitudinally along top and bottom surfaces of airbox 14 to form a continuous seam 36. In this way, vertical seam 36 differs from a horizontal seam that would extend horizontally and longitudinally in an embodiment of an airbox with upper and lower housings. Coupling the left housing 32 and right housing 34 by the vertical seam 36 provides the benefit of simpler tooling requirements in the manufacturing process and increased space available between the frame 4, engine 16, and fuel tank 12.

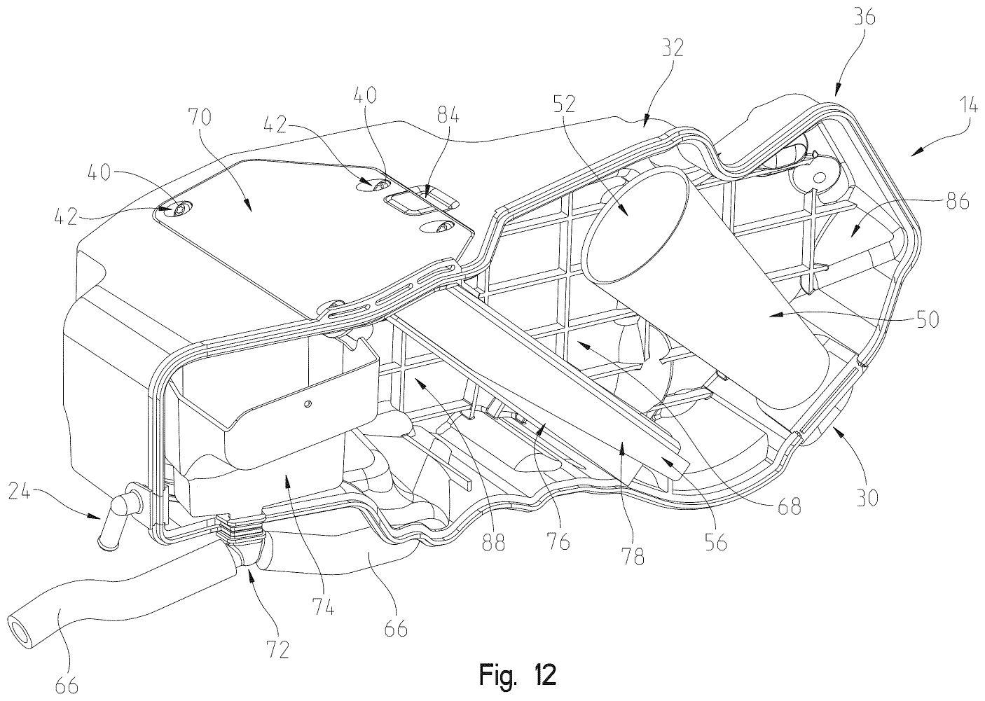

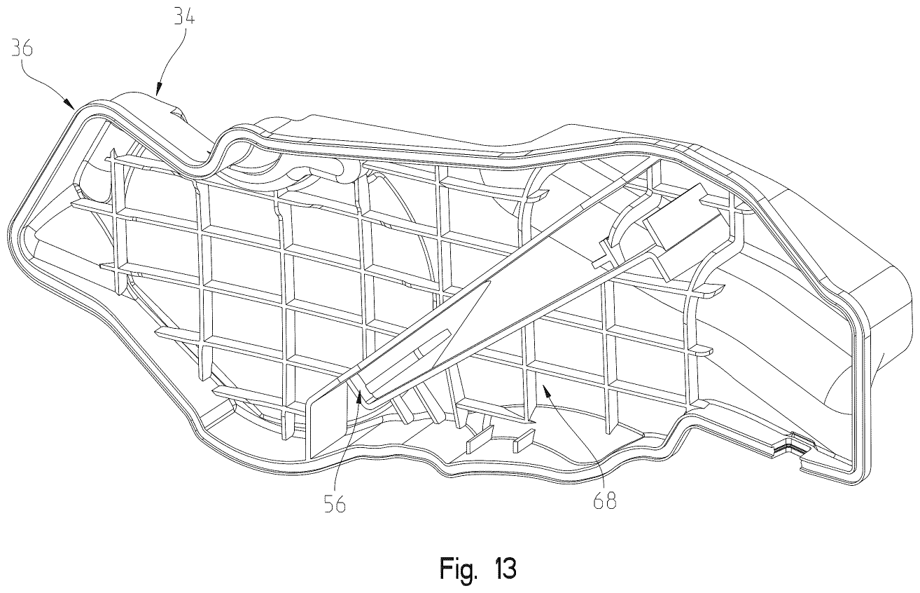

The interior of left housing 32 (FIG. 12) and right housing (FIG. 13) may be defined by a rib structure 68. Rib structure 68 provides stiffness to the airbox 14 and mitigates radiated acoustic response from airbox 14 panel modes excited by intake pressure dynamics. The left housing 32 has mountings for the radiator fill neck 58 (FIG. 3) to be coupled to the airbox 14. This provides the benefit of making the radiator fill neck 58 the highest point of the cooling system. As shown in FIG. 12, the interior space at the rear of airbox 14 may be configured to support an oil separator 74 to capture oil and prevent oil from entering or being recirculated through the throttle body assembly 46. The oil separator 74 may be removably or permanently coupled to at least a portion of airbox 14, such as left housing 32. In one embodiment, the oil separator 74 may be vibration welded to the vertical seam 36 to prevent air leaks and maintain pressure within the airbox 14. The oil separator 74 returns captured oil to the oil system (not shown) via coupling 72 and at least one of hoses 66.

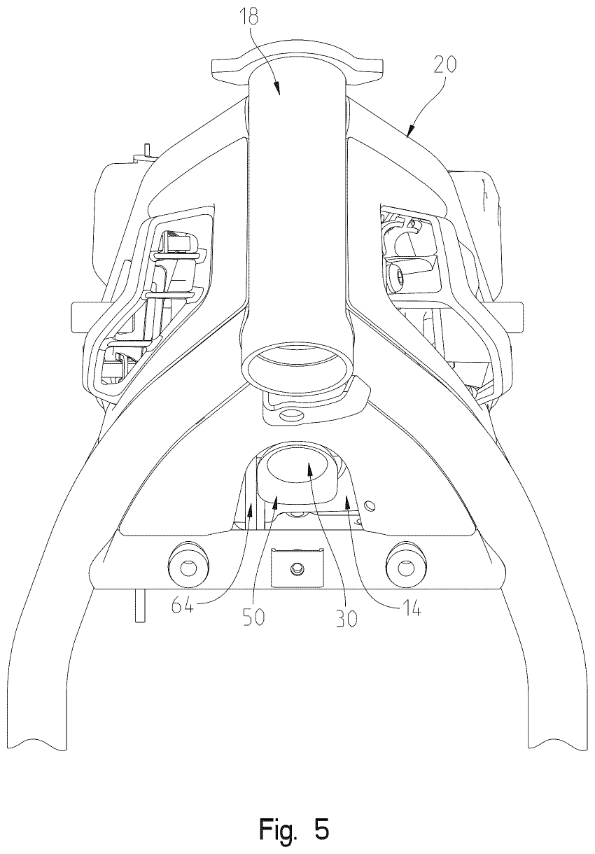

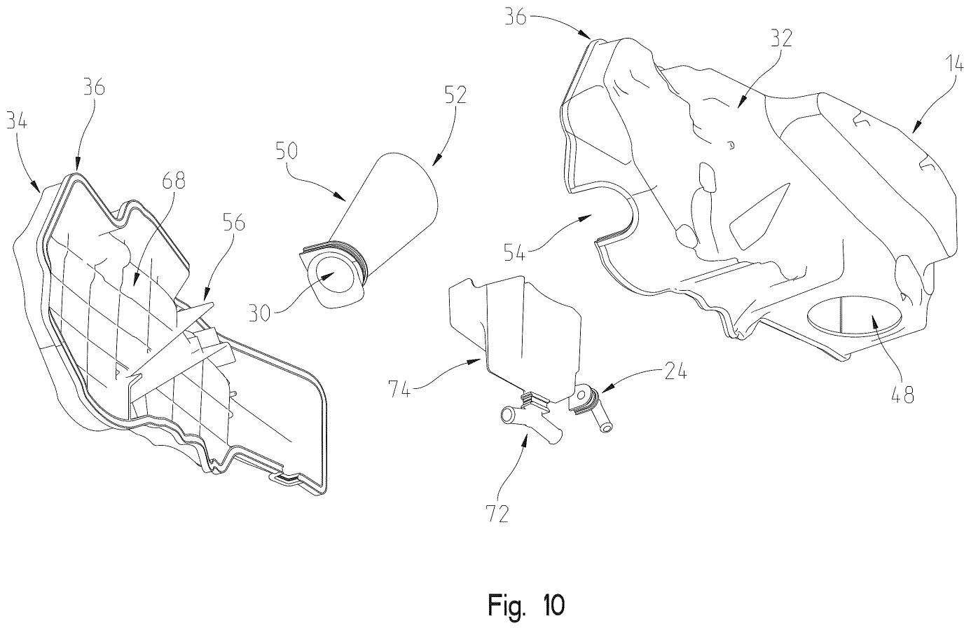

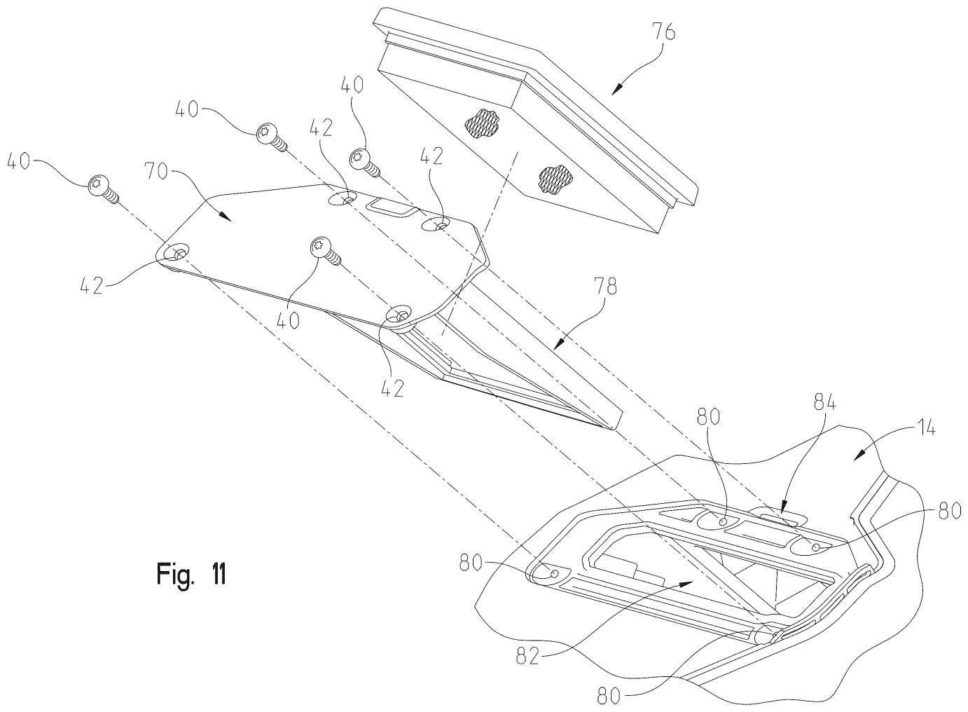

As shown in FIGS. 5, 9, 10, and 12, airbox 14 includes an inlet tube 50. Inlet tube 50 may be permanently or removably supported within airbox 14. In one embodiment, inlet tube 50 may be vibration welded to the vertical seam 36. The vibration weld mechanically and permanently fastens the inlet tube 50 to at least a portion of airbox 14, such as left housing 32, such that it is not removable to prevent air leaks and maintain pressure within the airbox 14. The opening 30 of inlet tube 50 is positioned in the front lower portion of airbox 14 in a pocket 64 between the down tubes 22. The opening 30 of inlet tube 50 captures airflow and directs it through the inlet tube 50 and outlet 52 into the air volume 86 of the airbox 14. Referring to FIGS. 10 and 12, the inlet tube 50 has a venturi design with a smaller diameter opening 30 and a larger diameter outlet 52 which gives the inlet tube 50 a tapered configuration to minimize the total cross section at the opening 30. The diameter of the inlet opening 30 may be a range from twenty to thirty-five millimeters. The diameter of the outlet 52 may be a range from twenty-five to seventy millimeters. The length of the inlet tube 50, from the opening 30 to the outlet 52, may be a range from one hundred to two hundred millimeters. The venturi design creates a pressure differential within the inlet tube 50 to maximize airflow capture. The inlet tube 50 is angled within the airbox 14 with a distance between the outlet 52 and opening 30 of inlet tube 50 designed to maximize space for air volume 86 within the airbox 14 while conserving space for other components on vehicle 2. In some instances, the inlet tube 50 may have a smaller or larger diameter opening 30 based on the desired performance characteristics of the vehicle 2. A larger diameter opening 30 would have higher performance characteristics than a smaller diameter opening 30.

Airbox 14 further includes a filter 76 for filtering the incoming air before it flows to engine 16. The filter 76 is coupled to the airbox 14 by a tray 78 which sits on rails 56 on both the left housing 32 and right housing 34 on the interior of the airbox 14. As shown in FIG. 11, the tray 78 is coupled to a cover 70 which defines a portion of the top of left housing 32 when the apertures 42 of tray 78 are aligned with the apertures 80 on the left housing 32. The tray 78 may be inserted through opening 82 and is positioned within or onto rails 56. Once tray 78 is installed, fasteners 40 may be inserted through apertures 42 on cover 70. A recess 84 on left housing 32 assists with removal of tray 78. The tray 78 provides for easy installation, removal, and replacement of filter 76. The filter 76 and tray 78 separate the interior of the airbox 14 into two portions, one portion being a pre-filtered or dirty air volume 86 toward the front of airbox 14 and upstream or forward of filter 76, and the other portion being a clean air volume 88 toward the rear of airbox 14 and downstream or rearward of filter 76. Rails 56 receive tray 78 and maintain its position at an angle of approximately 30-60 degrees (e.g., 43-degrees) from the ground plane within the airbox 14. The angle maximizes filter 76 surface area and total clean air volume 88.

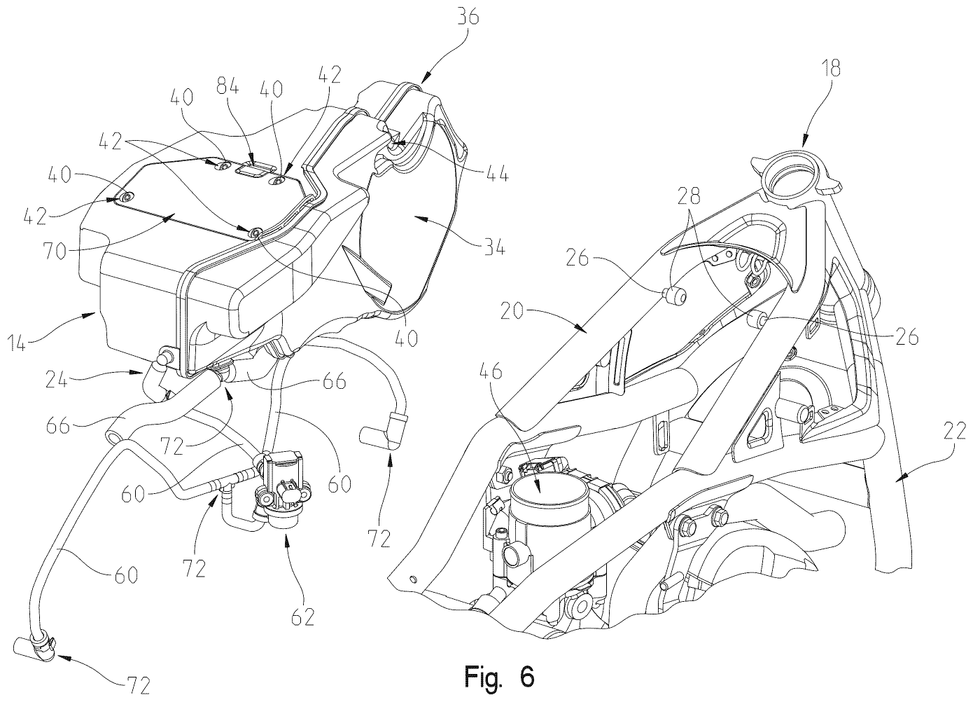

In operation, airbox 14 is configured to receive ambient air at the opening 30 of inlet tube 50, flow the air through air volume 86, and through filter 76 to provide filtered air from clean air volume 88 to throttle body assembly 46 for flowing into engine 16 for combustion therein. Additionally, and referring to FIG. 12, in some instances the airbox 14 may couple to a second air outlet 24 on the left housing 32 to provide filtered air to a secondary air injection system (not shown) for combustion therein. Referring to FIG. 6, the second body air outlet 24 could be coupled to a solenoid valve 62 via hose 60 for fluidly coupled to the exhaust ports (not shown). The secondary air injection system may provide filtered air to the exhaust ports (not shown) during engine 16 startup to warm the catalyst more rapidly and decrease engine 16 emissions output.

### EXAMPLES

Example 1: A two-wheeled vehicle may comprise a frame; a plurality of ground engaging members for supporting the frame; and an airbox. The airbox may include a left housing, a right housing distinct from the left housing, and a vertical seam separating the left and right housings.
Example 2: The two-wheeled vehicle of Example 1, wherein the left housing may be welded to the right housing at the vertical seam.
Example 3: The two-wheeled vehicle of Example 1, wherein at least one of the left housing and right housing may have an internal rib structure.
Example 4: The two-wheeled vehicle of Example 1, wherein a radiator fill neck may be mounted to the exterior of one of the left housing and the right housing.
Example 5: The two-wheeled vehicle of Example 1, wherein the airbox may include an inlet tube having an outlet opening and an inlet opening, and the inlet opening may be smaller than the outlet opening.
Example 6: The two-wheeled vehicle of Example 5, wherein the inlet tube may be angled between the inlet opening and the outlet opening.
Example 7: The two-wheeled vehicle of Example 1, wherein the airbox may include a second air outlet.
Example 8: A two-wheeled vehicle may comprise a frame; a plurality of ground engaging members for supporting the frame; and an airbox. The airbox may include a first housing portion, a second housing portion distinct from the first housing portion, and a filter. The filter may be positioned within one of the first housing portion and the second housing portion.
Example 9: The two-wheeled vehicle of Example 8, wherein the filter may be angled relative to the ground plane within the airbox.
Example 10: The two-wheeled vehicle of Example 8, wherein the filter may be coupled to the airbox by a tray.
Example 11: The two-wheeled vehicle of Example 10, wherein the tray may be supported in the airbox by rails.

While this invention has been described as having an exemplary design, the present invention may be further modified within the spirit and scope of this disclosure. This application is therefore intended to cover any variations, uses or adaptations of the invention using its general principles. Further, this application is intended to cover such departures from the present disclosure as come within known or customary practice in the art to which this invention pertains.

What is claimed is:

1. A two-wheeled vehicle, comprising:
a frame;
a plurality of ground engaging members for supporting the frame; and
an airbox including a left housing, a right housing distinct from the left housing, and a vertical seam separating the left and right housings.

2. The two-wheeled vehicle of claim 1, wherein the left housing is welded to the right housing at the vertical seam.

3. The two-wheeled vehicle of claim 1, wherein at least one of the left housing and right housing has an internal rib structure.

4. The two-wheeled vehicle of claim 1, wherein a radiator fill neck may be mounted to the exterior of one of the left housing and the right housing.

5. The two-wheeled vehicle of claim 1, wherein the airbox includes an inlet tube having an outlet opening and an inlet opening, and the inlet opening is smaller than the outlet opening.

6. The two-wheeled vehicle of claim 5, wherein the inlet tube is angled between the inlet opening and the outlet opening.

7. The two-wheeled vehicle of claim 1, wherein the airbox includes a second air outlet.

8. A two-wheeled vehicle, comprising:
a frame;
a plurality of ground engaging members for supporting the frame; and
an airbox including a first housing portion, a second housing portion distinct from the first housing portion, and a filter positioned within one of the first housing portion and the second housing portion.

9. The two-wheeled vehicle of claim 8, wherein the filter is angled relative to the ground plane within the airbox.

10. The two-wheeled vehicle of claim 8, wherein the filter is coupled to the airbox by a tray.

11. The two-wheeled vehicle of claim 10, wherein the tray is supported in the airbox by rails.
